(19) United States
(12) Patent Application Publication
(10) Pub. No.: US 2005/0214405 A1
(43) Pub. Date: Sep. 29, 2005

(54) Injection device in injection molding machine and injection molding machine

(75) Inventor: Tetsunori Matsumoto, Ihara-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOSHIBA KIKAI KABUSHIKI KAISHA

(21) Appl. No.: 11/088,201

(22) Filed: Mar. 24, 2005

(30) Foreign Application Priority Data
Mar. 25, 2004 (JP) 2004-089259

(51) Int. Cl. B29C 45/50

(52) U.S. Cl. 425/587

(57) ABSTRACT

The injection device according to the present invention includes a screw (1) formed in the vertical direction, a screw advancing/retracting AC servo motor (41) for screw for generating a torque by rotating a rotor (412), and a driving force converting unit (42) for converting the torque to a linear driving force to move the screw (1) in the vertical direction, the AC servo motor (41) including a first brake unit for maintaining the rotor (412) in the rest state. By actuating the first brake unit, movement of the screw (1) in the vertical direction due to the tare weight can be prevented.

### BACKGROUND OF THE INVENTION

1. Field of the Invention

The present invention relates to an injection device in an injection molding machine and to an injection molding machine. More specifically this invention relates to an injection device for injecting a melted material into a molding die by moving a screw, and an injection molding machine including the injection device.

2. Description of Related Art

There has been known a vertical injection molding machine (Refer to, for instance, Reference: Japanese Patent Laid-Open Publication No. HEI 5-84789, FIG. 1 to FIG. 5, FIG. 9, and FIG. 10).

An injection device in this type of vertical injection molding machine includes a cylinder unit having a nozzle at a tip end thereof, a screw accommodated within this cylinder unit with a spiral groove formed on an outer peripheral surface thereof, a rotating unit for rotating the screw around the axis line as a central axis, a hopper for feeding resin as a molding material into the groove of the screw, a band heater for heating and melting the resin fed into the groove of the screw, an injection motor for generating a torque by rotating a rotor rotatably provided, and a driving force converting unit for converting the torque generated by the injection motor to a linear driving force. The screw is provided with the axial line oriented in the vertical direction.

This injection device is a device for injecting the melted resin through a nozzle into a die by moving the screw along the axial direction (vertical direction) with the linear driving force generated by conversion with the driving force converting unit.

The rotating unit includes a measuring motor, a first belt for transmitting rotations of the measuring motor, a first toothed pulley with the first belt spanned thereon, and a screw extension shaft contacted to the first toothed pulley. The screw extension shaft is provided on an extension line of the screw and is attached to an upper end of the screw. Further the screw extension shaft is rotated in association with rotations of the first toothed pulley around the axial line as the central axis. With the configuration as described above, rotations of the measuring motor is transmitted to the screw, so that the screw is rotated around the axial line as the central axis.

The driving force converting unit includes a second belt for transmitting a torque of the injection motor, a second toothed pulley with the second belt spanned thereon, a ball nut contacted to the second toothed pulley, and a ball screw screwed into the ball nut. The ball screw is rotated in association with rotation of the second toothed pulley. Then the ball nut is moved along the axial direction. Because of this configuration, the torque generated by the injection motor is converted to a linear driving force of the ball screw. The ball screw is provided on an extension line of the axial line of the screw, so that the screw is moved in the axial direction by the linear driving force of the ball screw.

Then operations of the injection device will be described below.

The injection device performs a step of measuring melted resin and a step of injection alternately, and the step of injecting melted resin will be described first. The following description assumes that a prespecified quantity of melted resin measured in the later-described measuring step has been stocked in a space formed under the screw in the cylinder unit.

In the injection step, the injection motor is rotated. A torque of the injection motor is converted to a linear driving force by the driving force converting unit. Then the screw is moved by the linear driving force downward along the axial direction (vertical direction). Then the prespecified quantity of melted resin having been measured and stocked in the space formed under the screw in the cylinder unit is pushed out by the screw and injected into the die through the nozzle.

The melted resin injected into the die is cooled and solidified in the die, and is demolded as a molded product. In the period of time, measurement of the melted resin is performed in the injection device. Measurement of the melted resin is performed by rotating the measuring motor and the injection motor simultaneously.

When the measuring motor is rotated, the resin fed from the hopper into the groove on the screw is moved toward a tip end (lower end) of the screw along the groove of the screw. The resin is heated by the band heater during transfer, and has been melted when the resin reaches the tip end (lower end) of the screw.

The injection motor is rotated in a direction reverse to that in the injection step. Therefore, the screw is then moved upward. When the screw is moved upward, a space is formed under the screw in the cylinder unit in proportion to movement of the screw, and the melted resin to be transferred as described above is stocked in the space.

By controlling rotations of the measuring motor and the injection motor, a quantity of the melted resin stocked in the space under the screw in the cylinder unit is adjusted, so that a prespecified quantity of melted resin can be measured.

After the measuring step is finished, the injection device again starts the injection step and injects the melted resin into the die.

As described above, the injection device performs the injection step and measuring step alternately and repeatedly.

In the injection device disclosed in the Reference, as described above, the screw can move in the axial direction (in the vertical direction) in association with rotation of the injection motor. As the axial line of the screw is in the vertical direction, gravity loaded to the screw is in the axial direction. Thus, since the direction in which the screw is movable (axial direction) and the direction of gravity are identical, a force moving the screw downward along the axial direction (gravity) is always loaded to the screw. This force is transmitted, through the driving force converting unit, to the injection motor to rotate the rotor of the injection motor, which moves the screw downward in the vertical direction. In other words, the screw moves downward in the vertical direction due to a tare weight thereof.

When the screw moves downward due to the tare weight, various problems occur. For instance, if the screw moves downward due to the tare weight while melted resin is measured and stocked in the space formed under the screw in the cylinder unit, the melted resin is compressed, so that pressure rises. Then a higher injection pressure is required for injecting the melted resin into the die. An injection pressure is an important factor affecting a quality of a molded product, and when the injection pressure goes higher, abnormality such as flashes is easily generated in the molded product. Further, when a pressure of the melted resin is raised, sometimes the melted resin disadvantageously leaks from the nozzle.

### SUMMARY OF THE INVENTION

An object of the present invention is to provide an injection device capable of preventing the screw from moving due to the tare weigh and also to provide an injection molding machine including this injection device.

The injection device according to an aspect of the present invention includes a cylinder having a nozzle at an end thereof, a screw accommodated within this cylinder with a spiral groove formed on an external peripheral surface thereof, a rotating unit for rotating the screw around the axial line as the central axis, a material feeding unit for feeding a material for a molded product into the groove of the screw, a heating unit for heating and melting the material fed into the groove of the screw, a first motor for generating a torque by rotating a first rotor rotatably provided, and a driving force converting unit for converting the torque generated by the first motor to a linear driving force, in which the screw is moved along the axial line by the linear driving force provided by the driving force converting unit to inject the melted material from the nozzle into a molding die, and the axial line of the screw crosses the horizontal direction and the first motor has a first brake unit for maintaining the first rotor in the rest state.

The injection device according to the present invention performs a measuring step and an injection step alternately and repeatedly. The measuring step is a step of measuring the melted material, and the injection step is a step of injecting the melted material measured in the measuring step through the nozzle formed at an end of the cylinder into a molding die. The melted material injected into the molding die is cooled and solidified in the molding die and is demolded as a molded product. The injection device repeats execution of a cycle including the measuring step and the injection step, so that the same number of molded products as the number of cycles is produced.

First, the injection step will be described. The following description assumes that a prespecified quantity of melted material measured in the later-described measuring step described hereinafter has been stocked in a space formed in front of the screw in the cylinder (hereinafter, the direction in which the screw is moved when the melted material is injected into the molding die is defined as forward and the direction in which the screw is moved in the measuring step described later is defined as backward. Further a forward end of the screw is defined as a tip end and a backward end as a rear end).

In this state, the first rotor in the first motor starts rotating. In this step, the first brake unit is not operated, so that the first rotor can freely rotate. The torque generated by rotation of the first rotor is converted to a linear driving force by the driving force converting unit, and the screw is advanced forward along the axial line because of the linear driving force (hereinafter, moving in the direction from the rear end of the screw to the tip end thereof is expressed as advancing and moving in the reverse direction as retracting). Since the melted material has been stocked in a space formed in front of the screw in the cylinder, when the screw is advanced, the melted material is pushed out and injected into the molding die through the nozzle.

After the injection step is finished, the injection device starts the measuring step. The measuring step in the injection device is performed concurrently with the step of cooling and solidifying the melted material in the molding die and the step of demolding the molded product from the molding die. Measurement of the melted material is performed by rotating the screw with the rotating unit and also rotating the first rotor in a direction reverse to that in the injection step. Also in this step, the first brake unit is not operated, so that the first rotor can freely rotate.

When the screw is rotated by the rotating unit, the material fed into the groove of the screw by the material feeding unit is transferred to a tip end of the screw along the groove of the screw. The material is heated and melted by the heating unit.

On the other hand, the screw is moved along the axial line in association with rotation of the first rotor. Since the rotating direction of the first rotor is reverse to that in the injection step, the screw is retracted. Then, the space is formed in front of the screw in the cylinder. Then, the melted material having been transferred to the tip end of the screw by the rotating unit as described above is stocked in this space.

A quantity of melted material stocked in the space formed in front of the screw in the cylinder is determined by a rotating distance of the screw by the rotating unit or a retracting distance of the screw associated with rotation of the first rotor, and a prespecified quantity of the melted material can be measured by controlling these factors.

When all of the measuring step in the injection device, step of cooling and solidifying the melted material in the molding die, and step of demolding the molded product from the molding die are finished, the injection step is again started in the injection device. In the period of time after the measuring step is finished in the injection step until the injection step is started, the first brake unit is operated, and the first rotor is maintained in the rest state. Therefore, the screw does not move along the axial direction and is maintained at the position.

Immediately when the injection step is started in the injection device, the first brake unit is released to allow rotation of the first rotor, so that the screw is advanced.

As described above, in the injection device according to the present invention, the measuring step and injection step are performed alternately and repeatedly, so that molded products are produced successively.

Although the gravity is loaded to the screw in the vertical direction, since the axial line of the screw crosses the horizontal line, the gravity includes a component in the axial direction of the screw, so that the screw is moved in the axial direction according to the vector. The force being loaded to the screw is transmitted to the first motor through the driving force converting unit to rotate the first rotor. If the first rotor is rotated by this force, the problem as disclosed in the Reference above occurs. With the present invention, however, as the first brake unit is provided, the first rotor can be prevented from being rotated.

The first brake unit is kept effecting operation during the period after the measuring step in the injection device is finished until the injection step is started. During this period of time, the measured quantity of melted material is stocked in the space formed in front of the screw in the cylinder, but since the first brake unit is fixed by the screw, it never occurs that the screw is advanced or retracted due to the tare weight to raise or lower the pressure in the melted material. Because of the feature, the molding quality is not degraded due to the raised injection pressure, nor does leakage of the melted material from the nozzle occur. As described above, with the present invention, as a pressure of the melted material can be maintained at a constant level, so that degradation of the molding quality can be prevented.

In the injection device according to the present invention, it is preferable that the driving force converting unit includes a feed screw shaft provided along the same direction as the axial line of the screw and a female screw member screwed into the feed screw shaft, and either one of the feed screw shaft and the female screw member is attached to the screw, and the other one of the feed screw shaft and the female screw member is rotated according to the torque generated by the first motor.

First, a case where the feed screw shaft is attached to the screw and the female screw member is rotated according to the torque generated by the first motor will be described.

When the female screw is rotated due to the torque generated by the first motor, the feed screw shaft screwed with the female screw member is moved in the axial direction. Then also the screw is moved. As the axial direction of the screw is identical to that of the feed screw shaft, the screw is moved along the axial direction thereof.

Next, in a case where the female screw member is attached to the screw and the feed screw shaft is rotated according to the torque generated by the first motor, when the feed screw shaft is rotated by the first motor, the female screw member screwed therewith is moved along the axial line of the feed screw shaft. Then, also the screw is moved along the axial line of the feed screw shaft. As the axial direction of the screw is identical to the axial line of the feed screw shaft, so that the screw is moved along the axial line thereof.

With the present invention, the driving force converting unit can be simplified. Because of this feature, the driving force converting unit can be manufactured in a small size with low production cost.

In the injection device according to the present invention, it is preferable that the rotating unit includes a second motor for generating a torque by rotating a second rotor rotatably provided and a driving force transmitting unit for transmitting the torque generated by this second motor to the screw, the second motor including a second brake unit for maintaining the second rotor in the rest state.

In the present invention, the screw is rotated by the second motor.

With the present invention, since the second brake unit is provided, the second rotor can be maintained in the rest state by actuating the second brake unit, so that the screw does not rotate.

The screw is required to be rotated only in the measuring step in the injection device. Thus, if the screw is rotated for some reason or other in steps other than the measuring step, unnecessary movement of the melted material occurs, which degrades the molding quality. In other words, an excessive quantity of melted material may be transferred to a space formed in front of the screw in the cylinder or the melted material stocked in the space formed in front of the screw in the cylinder may be flown backward to the rear end according to a rotating direction of the screw. When a quantity of melted material stocked in the space formed in front of the screw in the cylinder varies, also a quantity of injected melted material varies as well as the injection pressure, which may cause degradation of the molding quality.

With the present invention, however, the second rotor can be maintained by the second brake unit in the rest state, so that rotation of the screw can be prevented. Further by actuating the second brake unit in other steps than the measuring step, the melted material can be prevented from moving in steps other than the measuring step. Because of this feature, since a quantity of the melted material stocked in the space formed in front of the screw in the cylinder does not vary, degradation of the molding quality can be prevented.

An injection molding machine of the present invention includes the above-described injection device according to the present invention.

Since the injection molding machine includes the injection device according to the present invention, the same effects and advantages as the injection device according to the present invention as described above can be obtained.

### BRIEF DESCRIPTION OF THE DRAWINGS

FIG. 1 is a view showing a state of an injection device according to an embodiment of the present invention; and

FIG. 2 is a view showing another state of the injection device according to the embodiment.

### DETAILED DESCRIPTION OF PREFERRED EMBODIMENT(S)

An embodiment of the present invention will be described below with reference to the attached drawings.

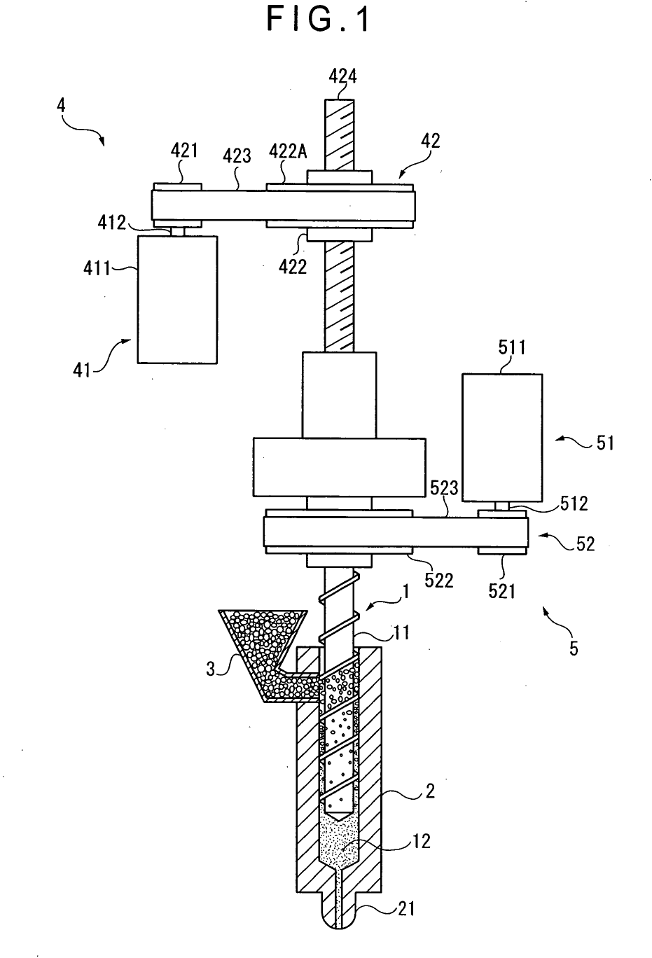

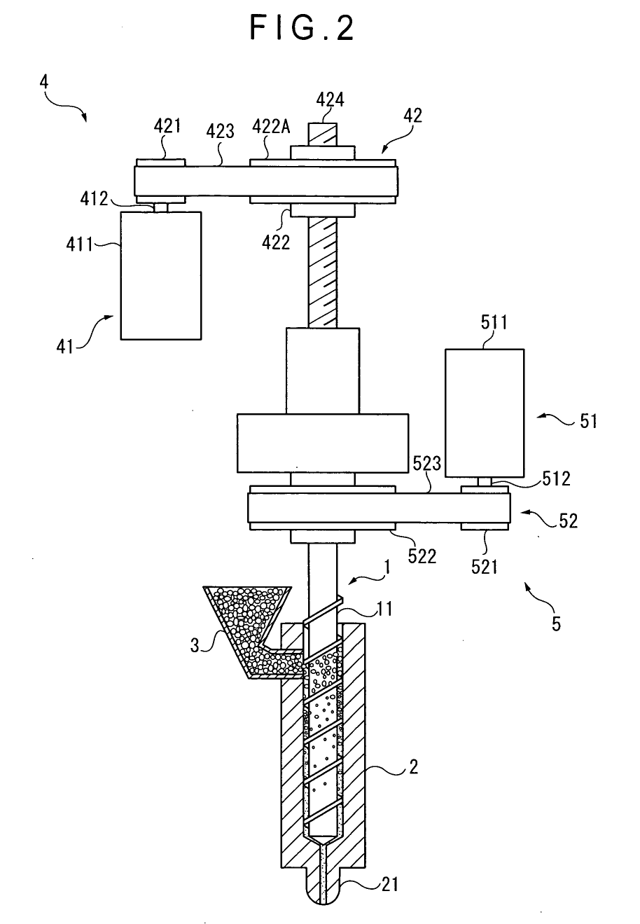

FIG. 1 and FIG. 2 are views each showing an injection device according to the present embodiment. FIG. 1 is a view showing a state at a time when the measuring step described later is completed, and FIG. 2 is a view showing the state at a time when the injection step described later is completed.

The injection device of the present embodiment includes a screw 1 with a spiral screw groove 11 formed on an external peripheral surface thereof, a cylindrical heating cylinder 2 for heating the screw 1, a hopper 3 as a material feeding unit for feeding resin as a material for molded product into the screw groove 11, a screw advancing/retracting unit 4 for advancing and retracting the screw 1 along the axial line, and a screw rotating unit 5 for rotating the screw 1 around the axial line as the central axis.

An axial line of the screw 1 is oriented in the vertical direction, and crosses the horizontal line at the right angle. An external peripheral surface of the screw 1 contacts an internal wall of the heating cylinder 2, and the screw 1 can be advanced and retracted in the vertical direction inside the heating cylinder 2 by the screw advancing/retracting unit 4.

The heating cylinder 2 has a band heater (not shown) as a heater for heating and melting the resin fed from the hopper 3 into the screw groove 11. The band heater is provided on an external peripheral surface of the heating cylinder 2. A nozzle 21 is provided at a tip end (lower end) of the heating cylinder 2. A molding die (not shown) is provided under the nozzle 21, and the melted resin is injected via the nozzle 21 into the molding die.

The screw advancing/retracting unit 4 includes a screw advancing/retracting AC servo motor 41 as a first motor for generating a torque, a driving force converting unit 42 for converting the torque generated by the AC servo motor 41 to a linear driving force in the vertical direction. The screw 1 is advanced and retracted by the linear driving force in the vertical direction generated by the driving force converting unit 42 along the axial line (in the vertical direction).

The AC servo motor 41 includes a stator 411, a first rotor 412 provided rotatably, and a first brake unit (not shown) for maintaining the rotor 412 in the rest state. The AC servo motor 41 generates a torque by rotating the first rotor 412. When the first brake unit is operated, the first rotor 412 can not rotate, and when the first brake unit has been released, the first rotor 412 can rotate.

The driving force converting unit 42 includes a gear 421 attached to the rotor 412 and rotated in association with rotation of the rotor 412, a ball nut 422 as a female screw member having a gear section 422A on an external peripheral surface thereof, a timing belt 423 spanned over the gear 421 and the gear section 422A, and a ball screw shaft 424 as a feed screw shaft screwed into the ball nut 422.

The ball nut 422 is rotatably provided. The torque generated in the AC servo motor 41 is transmitted via the gear 421, timing belt 423, and gear section 422A to the ball nut 422 to rotate the ball nut 422.

A lower end (not shown) of the ball screw shaft 424 is attached to an upper end (not shown) of the screw 1. The axial line of the ball screw shaft 424 is oriented in the vertical direction, and the ball screw shaft 424 can move in the vertical direction. Also the axial line of the screw 1 is oriented in the vertical direction, so that the axial line of the ball screw shaft 424 is in the same direction as that of the screw 1.

The screw rotating unit 5 includes a screw rotating AC servo motor 51 as a second motor for generating a torque, and a torque transmitting unit 52 for transmitting the torque generated by the AC servo motor 51 to the screw 1.

The AC servo motor 51 includes a stator 511, a second rotor 512 provided rotatably, and a second brake unit (now shown) for maintaining the rotor 512 in the rest state. The AC servo motor 51 generates a torque by rotating the rotor 512. When the second brake unit is operated, the rotor 512 can not rotate, and when the second brake unit is released, the rotor 512 can rotate.

The torque transmitting unit 52 includes a gear 521 attached to the rotor 512 and rotated in association with the rotor 512, a screw rotating gear 522 rotatably provided, and a timing belt 523 spanned over the gear 521 and the screw rotating gear 522.

The screw rotating gear 522 is attached to the screw 1, and when the screw rotating gear 522 is rotated, the screw 1 is rotated around the axial line as the central axis.

Operations of the injection device according to the present embodiment will be described below.

The injection device according to the present embodiment performs a measuring step and an injection step alternately and repeatedly. The measuring step is a step for measuring the melted resin, and the injection step is a step for injecting the melted resin measured in the measuring step through the nozzle 21 of the heating cylinder 2 into a molding die. The melted resin injected into the molding die is cooled and solidified in the molding die and demolded as a molded product. Every time the injection device repeats a cycle of the measuring step and the injection step to successively inject melted resin into the molding die, a new molded product can be produced in the molding die.

First, the injection step will be described. The following descriptions assume that a prespecified quantity of melted resin measured in the measuring step described below has been stocked in the space 12 formed under the screw 1 in the heating cylinder 2 as shown in FIG. 1.

In this state, the rotor 412 in the AC servo motor 41 starts rotating. In this step, the first brake unit is not operated, so that the first rotor 412 can rotate. When the first rotor 412 rotates, the gear 421 is rotated in association with rotation of the rotor 412. This rotation is transmitted via the timing belt 423 to the gear section 422A in the ball nut 422, so that the ball nut 422 is rotated. Then, the ball screw shaft 424 screwed into the ball nut 422 is moved downward along the axial line (in the vertical direction). Since a lower end of the ball screw shaft 424 is attached to an upper end of the screw 1, also the screw 1 is moved downward along the axial line (in the vertical direction) in association with downward movement of the ball screw shaft 424. Since the melted resin has been stocked in the space 12 formed under the screw 1 in the heating cylinder 2, when the screw 1 is moved downward, the melted resin is pushed out and is injected through the nozzle 21 into the molding die.

During the injection described above, the second brake unit is operated, and the rotor 512 is maintained in the rest state, so that rotation of the screw 1 is prevented.

Next, measuring step will be described. The measuring step is performed in succession to the injection step described above. While the measuring step is being executed in the injection device, the step of cooling and solidifying the melted resin injected into the molding die in the injection step and the step of demolding the molded product are executed in the molding die.

When the measuring step is started, namely, when the injection step is finished, as shown in FIG. 2, the screw 1 is contacted to a lower end of the heating cylinder 2. In this state, the rotor 412 in the AC servo motor 41 and the rotor 512 in the AC servo motor 51 start rotating. In this state, both the first and second brake units are not operated, so that the rotor 412 and the rotor 512 can rotate.

A rotating direction of the rotor 412 in the AC servo motor 41 is reverse to that in the injection step, and therefore the screw 1 is moved upward in the vertical direction (along the axial line). Then, as shown in FIG. 1, the space 12 is formed under the screw 1 in the heating cylinder 2.

When the rotor 512 in the AC servo motor 51 is rotated, the gear 521 is rotated in association with rotation of the rotor 512. Rotation of the gear 521 is transmitted via the timing belt 523 to the screw rotating gear 522, and the screw rotating gear 522 is rotated. Since the screw rotating gear 522 is attached to the screw 1, when the screw rotating gear 522 is rotated, the screw 1 is rotated around the axial line as the central axis. Thus, when the rotor 512 is rotated, also the screw 1 is rotated. The rotating direction of the rotor 512 is previously specified, and when the rotor 512 is rotated in the prespecified direction and also the screw 1 is rotated in association with rotation of the rotor 512, the resin fed into the screw groove 11 is transferred to a tip end (lower end) of the screw 1.

When the screw 1 is rotated in association with rotation of the rotor 512, the resin fed from the hopper 3 into the screw groove 11 is transferred to the tip end (lower end) of the screw 1. While the resin is being transferred, the resin is heated by the band heater provided in the heating cylinder 2 and is also heated and melted by shearing heat or frictional heat generated in association with rotation of the screw 1. Also the shearing heat and frictional heat are included in the heat generated by the heating unit according to the present invention. As described above, the resin is transferred to the tip end (lower end) of the screw 1 in the melted state, and is stocked in the space 12 formed under the screw 1 in the heating cylinder 2 when the rotor 412 is rotated as described above (Refer to FIG. 1).

A quantity of the melted resin stocked in the space 12 formed under the screw 1 in the heating cylinder 2 is determined by a retracting distance of the screw 1 (a distance of the upward movement in the vertical direction) and a rotating distance of the screw 1. These distances are controlled by the AC servo motors 41 and 51. A prespecified quantity of melted resin is stocked in the space 12 formed under the screw 1 in the heating cylinder 2 under the controls as described above, so that a quantity of the melted resin is measured.

After the measuring step in the injection device, the step of cooling and solidifying the melted resin, and the step of demolding the molded product are finished, the injection step is again started in the injection device. During a period of time after the measuring step in the injection device is finished until the injection step is started, the first brake unit and the second brake unit are operated, so that the rotors 412 and 512 are maintained in the rest state. Because of the feature, the screw 1 is not moved along the axial line (in the vertical direction), nor is rotated around the axial line as the central axis.

At the time when the injection step is started in the injection device, only the first brake unit is released in the injection device, so that the rotor 412 in the AC servo motor 41 starts rotating, and the screw 1 is advanced.

As described above, the measuring step and the injection step are performed alternately and repeatedly in the injection device of the present embodiment, and in association with the repeated operations, molded products are produced in succession.

The descriptions above assume that a power of the injection device has been turned on and the injection device is being operated.

On the other hand, when a power of the injection device has not been turned on, or when the measuring and injection steps are not performed even though power of the injection device is on, both the first brake unit and second brake unit are operated, so that the rotor 412 and rotor 512 are maintained in the rest state. Because of the feature, the screw 1 is not moved along the axial line (in the vertical direction), nor is rotated around the axial line as the central axis.

With the present embodiment, the following effects and advantages can be obtained.

(1) The screw 1 is moved along the axial line (in the vertical direction) in association with rotation of the rotor 412. The gravity (downward in the vertical direction) is loaded to the screw 1, so that an external force (gravity) for moving the screw 1 downward along the axial line (in the vertical direction) is always loaded to the screw 1. This force is transmitted to the rotor 412 via the ball screw shaft 424 attached to the upper end of the screw 1, ball nut 422, timing belt 423, and gear 421. Therefore, a force due to the gravity loaded to the screw 1 is always loaded to the rotor 412 to rotate the rotor 412. When the rotor 412 is rotated by the force, the screw 1 is moved downward in the vertical direction (along the axial direction), so that the same problems as that in the conventional technology as disclosed in the Reference occurs. In this embodiment, however, since the first brake unit is provided, and therefore, when the first brake unit is operated, rotation of the rotor 412 is prevented. Therefore, downward movement of the screw 1 due to the gravity loaded thereto in the vertical direction can be prevented.

During the period after the measuring step in the injection device is finished until the injection step is started, the first brake unit is operated, so that the screw 1 is stayed at the same position. In this case, since the measuring step has been finished, a measured quantity of melted resin has been stocked in the space 12 formed under the screw 1 in the heating cylinder 2. In this step, if the screw 1 is moved downward in the vertical direction due to the tare weight, the screw 1 presses the melted resin stocked in the space 12 to raise the pressure thereof. If a pressure of the melted resin is raised, the melted resin may leak from the nozzle 21, or a pressure for injection into the molding die is unnecessarily raised, which may degrade the molding quality. With the injection device according to the present embodiment, however, since the first brake unit is provided, the problem as described above does not occur. Because of the feature, the molding quality can be prevented from degrading.

Even when a power of the injection device is off, or when the power of the injection device is on but the measuring and injection steps in the injection device are not performed, the first brake unit is operated, so that movement of the screw 1 in the vertical direction due to the tare weight thereof can be prevented. Without the brake unit as described above, the screw 1 may drop, which also causes a problem relating to the safety, but with the present embodiment, also the problem as described above can be solved.

(2) The screw 1 is required to be rotated around the axial line as the central axis only in the measuring step. When the screw 1 is rotated for some reason or other in steps other than the measuring step, unnecessary movement of the melted resin occurs through the screw groove 11, resulting in degradation of the molding quality. In other words, an excessive quantity of melted resin may be transferred into the space 12 formed under the screw 1 in the heating cylinder 2 or the melted resin stocked in the space 12 formed under the screw 1 in the heating cylinder 2 may be flown back toward a rear end (upper end) of the screw 1 according to a direction in which the screw 1 is rotated. As described above, a quantity of melted resin stocked in the space 12 formed under the screw 1 in the heating cylinder 2 varies, so that a quantity of melted resin injected into the molding die or a pressure thereof or the like varies, which degrades the molding quality.

With the present embodiment, however, as the rotor 512 can be maintained in the rest state by the second brake unit, the screw 1 can be prevented from being rotated. Since the second brake unit is operated in steps other than the measuring step (namely in the injection step, or when a power of the injection device is off), unnecessary movement of the melted resin can be prevented. As a result, a quantity of the melted resin stocked in the space 12 formed under the screw 1 in the heating cylinder 2 and a pressure thereof do not vary, and therefore with the present invention, degradation of the molding quality can be prevented.

(3) The driving force converting unit 42 makes use of a feed screw mechanism including the ball nut 422 and ball screw shaft 424, so that the configuration can be simplified. Because of this feature, the injection device according to the present embodiment can be manufactured in a small size with low cost.

(4) As a brake mechanism for preventing movement of the screw 1 along the axial line (in the vertical direction), the first brake unit provided in the AC servo motor 41 is employed in this embodiment. In a case of a brake mechanism for preventing movement of the screw 1 along the axial line, for instance, by pressing a plurality of pressing pieces to an external peripheral surface of the screw 1 to brake the screw 1 with the frictional force generated between the pressing pieces and the screw 1, the configuration and mechanism are very complicated. In addition, such configuration requires a space for mounting the brake mechanism, so that a size of the device becomes larger with the weight increasing, and also the cost becomes higher. With the present embodiment, however, as the first brake unit is compactly accommodated within the AC servo motor 41, the problems as described above do not occur. Therefore, with the present embodiment, it is possible to reduce the size and weight of the injection device and also to produce the injection device with low cost.

In addition, in the present embodiment, the second brake unit compactly accommodated within the AC servo motor 51 is employed as a brake mechanism for preventing rotation of the screw 1 around the axial line as the central axis, so that the size and weight of the injection device can be reduced and the injection device can be produced with low cost.

The scope of the present invention is not restricted to the above-described embodiments, but includes modifications and improvements as long as an object of the present invention can be achieved.

For instance, in the embodiment described above, although the axial direction of the screw 1 is identical to the vertical direction, other direction may be employed as long as the axial line of the screw crosses the horizontal direction in the present invention. In this case, the gravity loaded to the screw has a component along the axial line of the screw, the screw may be moved due to the tare weight thereof. In the present invention, however, movement of the screw due to the component can be prevented by the first brake unit.

In the embodiment described above, the ball screw shaft 424 is attached to the screw 1, and the ball nut 422 is rotated by a torque generated in the AC servo motor 41, but in the present invention, the ball nut 422 may be attached to the screw 1 and the ball screw shaft 424 may be rotated around the axial line as the central axis by a torque generated in the AC servo motor 41. With the configuration as described above, when the ball screw shaft 424 is rotated by the AC servo motor 41, the ball nut 422 screwed therein is moved along the axial line of the ball screw shaft 424. Then, the screw 1 can move along the axial line thereof in association with movement of the ball nut 422.

In the embodiment described above, the feed screw mechanism including the ball nut 422 and the ball screw shaft 424 is used as a mechanism for advancing and retracting the screw 1 (in the vertical direction) with the driving force generated by the AC servo motor 41, but various types of mechanisms for converting a torque to a linear driving force may be used in the present invention. For instance, rack and pinion mechanism may be employed in the present invention. In this case, the rack is attached to the screw 1 so that the longitudinal direction is identical to the axial direction of the screw 1, and the pinion may be rotated by a torque generated by the AC servo motor 41.

In the embodiment, the ball screw shaft 424 is provided on an extension line of the axial line of the screw 1, but in the present invention, it is required only that the axial line of the ball screw shaft 424 is identical to the axial line of the screw 1. With the configuration as described above, even if the ball screw shaft 424 is not provided on an extension line of the axial line of the screw 1, the screw 1 can move along the axial line thereof (identical to that of the ball screw shaft 424) in association with movement of the ball screw shaft 424 along the axial line thereof.

In the present embodiment described above, a torque generated by the AC servo motor 51 is used for rotating the screw 1 around the axial line as the central axis, but in the present invention, for instance, a torque generated by a hydraulic motor may be used.

In the embodiment described above, the AC servo motor 51 has the second brake unit, but in the present invention, the screw may be rotated by a torque generated by a serve motor not having the brake unit.

In the present invention, an injection molding machine including the injection device according to the present embodiment may be configured. With the injection molding machine, the effects and advantages in the embodiment described above can be provided.

The priority application Number JP2004-089259 upon which this patent application is based is hereby incorporated by reference.

1. An injection device comprising:
a cylinder having a nozzle at one end thereof;
a screw accommodated in this cylinder with a spiral groove formed on an external peripheral surface thereof;
a rotating unit for rotating this screw around the axial line as the central axis;
a material feeding unit for feeding a material of a molded product into the groove of the screw;
a heating unit for heating and melting the material fed into the groove of the screw;
a first motor for generating a torque by rotating a first rotor rotatably provided therein; and
a driving force converting unit for converting the torque generated by the first motor to a linear driving force,
the injection device of an injection molding machine moving the screw in the axial direction thereof by the linear driving force generated by the driving force converting unit to inject the melted material from the nozzle into a molding die,
wherein the axial line of the screw crosses the horizontal line, and
the first motor comprises a first brake for maintaining the first rotor in the rest state.

2. The injection device according to claim 1,
wherein the driving force converting unit comprises a feed screw shaft provided in the same direction as the axial direction of the screw and a female screw member screwed into the feed screw shaft,
either one of the feed screw shaft and the female crew member is attached to the screw, and
the other one of the feed screw shaft and the female screw member is rotated by a torque generated by the first motor.

3. The injection device according to claim 1,
wherein the rotating unit comprises a second motor for generating a torque by rotating a second rotor rotatably provided therein, and a torque transmitting unit for transmitting a torque generated by the second motor to the screw, and
the second motor comprises a second brake unit for maintaining the second rotor in the rest state.

4. An injection molding machine having an injection device, wherein the injection device comprises:
a cylinder having a nozzle at one end thereof;
a screw accommodated in this cylinder with a spiral groove formed on an external peripheral surface thereof;
a rotating unit for rotating this screw around the axial line as the central axis;
a material feeding unit for feeding a material of a molded product into the groove of the screw;
a heating unit for heating and melting the material fed into the groove of the screw;
a first motor for generating a torque by rotating a first rotor rotatably provided therein; and
a driving force converting unit for converting the torque generated by the first motor to a linear driving force,
the injection device used in the injection molding machine for moving the screw in the axial direction thereof by the linear driving force generated by the driving force converting unit to inject the melted material from the nozzle into a molding die,
the axial line of the screw crossing the horizontal line, and
the first motor comprising a first brake for maintaining the first rotor in the rest state.

5. The injection molding machine according to claim 4,
wherein the driving force converting unit comprises a feed screw shaft provided in the same direction as the axial direction of the screw and a female screw member screwed into the feed screw shaft,
either one of the feed screw shaft and the female crew member is attached to the screw, and
the other one of the feed screw shaft and the female screw member is rotated by a torque generated by the first motor.

6. The injection molding machine according to claim 4,
wherein the rotating unit comprises a second motor for generating a torque by rotating a second rotor rotatably provided therein, and a torque transmitting unit for transmitting a torque generated by the second motor to the screw, and
the second motor comprises a second brake unit for maintaining the second rotor in the rest state.
